(19) United States
(12) Patent Application Publication
(10) Pub. No.: US 2008/0174886 A1
(43) Pub. Date: Jul. 24, 2008

(54) IMAGE PICKUP LENS, IMAGE PICKUP APPARATUS, AND MOBILE TERMINAL

(76) Inventor: Masae Sato, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/015,997

(22) Filed: Jan. 17, 2008

(30) Foreign Application Priority Data
Jan. 24, 2007 (JP) JP2007-013588

(51) Int. Cl. G02B 9/00

(52) U.S. Cl. 359/754

(57) ABSTRACT

The present invention relates to an image pickup lens, an image pickup apparatus, and a mobile terminal. An image pickup lens relating to the present invention is provided for forming an object image on a photoelectrical converter of a solid-state image pickup element. The image pickup lens includes a plurality of lenses. A lens having a maximum positive refractive power among the plurality of lenses is a glass lens, and the rest of the plurality of lenses are resin lenses formed of a curable resin.

This application is based on Japanese Patent Application No. 2007-013588 filed on Jan. 24, 2007, in Japanese Patent Office, the entire content of which is hereby incorporated by reference.

### TECHNICAL FIELD

The present invention relates to an image pickup lens for an image pickup apparatus employing a solid-state image pickup element such as an image sensor of a CCD type and an image sensor of a CMOS type. In particular, the present invention relates to an image pickup lens that is capable of being mounted with reflow soldering to be suitable for mass production and has small fluctuation of a position of an image point caused by temperature changes, and to an image pickup apparatus and a mobile terminal employing the image pickup lens.

### BACKGROUND

A small and thin image pickup apparatus has so far been mounted on a mobile terminal representing a small and thin electronic device such as a cell-phone and PDA (Personal Digital Assistant), whereby, it has become possible to transmit not only voice information but also image information to a remote location each other.

As an image pickup element used for these image pickup apparatuses, there are used solid-state image pickup elements such as an image sensor of a CCD (Charge Coupled Device) type and an image sensor of a CMOS (Complementary Metal-Oxide Semiconductor) type. Further, for cost reduction of the lens that forms an image of a subject on the image pickup element, a lens formed with resins which can be inexpensively manufactured on a mass production basis has come to be used.

As the aforesaid image pickup lens used for an image pickup apparatus (which is also called a camera module, hereinafter) to be housed in a mobile terminal, there are known image pickup lenses of these types, a three-element structure formed of three plastic lenses and a three-element structure formed of one glass lens and two plastic lenses, for example, as shown in Japanese Patent Publication Open to Public Inspection (JP-A) No. 2005-242286.

Among the image pickup lenses disclosed in the JP-A No. 2005-242286, the three-element structure formed of three plastic lenses includes the first lens and second lens made of polyolefin resin material and the third lens made of polycarbonate resin material. While, the three-element structure formed of one glass lens and two plastic lenses includes the first lens made of glass material, the second lens made of polyolefin resin material and the third lens is made of polycarbonate resin material.

### SUMMARY

In recent years, a unit of a camera module having sufficient heat resistance is requested so that it may resist reflow, because it is possible to enhance work efficiency if automatic mounting with a reflow process is employed for the soldering for connecting an external terminal of a camera module to another circuit board.

To be concrete, mounting with a reflow process is achieved as follows: a temperature in a reflow oven is set to 200° C. or higher to facilitate remelting solder, then, a solder component is solidified by subsequent temperature lowering, and thereby, an external terminal (an electric contact point) of a camera module is connected to an electric conductor pad on an electronic circuit, and mechanical connection is achieved simultaneously. With the background of this kind, a strong demand for an image pickup lens having sufficient heat resistance that can resist the reflow has been actualized.

Though it is considered to constitute all elements in an image pickup lens with glass lenses because a glass lens is excellent in heat resistance, it is necessary to set pressing temperature for mold-pressing to be high because glass transition temperature (Tg) of a glass lens is generally as high as 400° C. or higher, which makes a molding die to be damaged easily. As a result, the number of replacements for a molding die and the number of maintenance operations are increased, resulting in a cost increase.

On the other hand, a plastic lens is inexpensive when comparing with a glass lens, and it is fit for mass production. In the image pickup lens described in the aforesaid JP-A No. 2005-242286, polycarbonate resin material and polyolefin resin material is used for a resin lens. However, these resin materials have low heat resistance. If elements formed of these materials are mounted with reflow soldering, they are easily melted and deformed, which is a problem. Therefore, the image pickup lens needs to be formed with resin materials excellent in heat resistance.

A resin material excellent in heat resistance includes curable resin, for example, energy-curable resin. As a typical example of energy-curable resin, there are given thermosetting resins and active-ray curable resins.

However, many of the resin materials suitable for an image pickup lens among the aforesaid resin materials excellent in heat resistance have a greater change of refractive index caused by temperature changes, compared with polycarbonate resin materials and polyolefin resin materials. Therefore, there has been a problem that fluctuation of a position of an image point caused by the changes of refractive index due to temperature changes is great. Many of image pickup apparatuses each housing therein an inexpensive image pickup lens, employ the so-called pan-focus type which has no automatic focusing mechanism for a lens. In the image pickup apparatuses of this type, fluctuations of image point positions due to temperature changes cannot be ignored.

Accordingly, in view of the aforesaid problems, the present invention provides an image pickup lens that has heat resistance capable of resisting a reflow process and has small fluctuation for an image point position due to temperature change, provides an image pickup apparatus for which automatic mounting with a reflow process is available by employing the aforesaid image pickup lens, and provides a mobile terminal including the image pickup apparatus.

An image pickup lens relating to the present invention is provided for forming an object image on a photoelectrical converter of a solid-state image pickup element. The image pickup lens comprises a plurality of lenses. A lens having a maximum positive refractive power among the plurality of lenses is a glass lens, and the rest of the plurality of lenses are resin lenses comprising a curable resin.

These and other objects, features and advantages according to the present invention will become more apparent upon reading of the following detailed description along with the accompanied drawings.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

FIG. 1 is a perspective view of an image pickup apparatus relating to the present embodiment;

FIG. 2 is a diagram showing a section along an optical axis of an image pickup lens of an image pickup apparatus relating to the present embodiment;

FIG. 3 is an appearance diagram of a cell-phone that is an example of a mobile terminal equipped with an image pickup apparatus relating to the present embodiment;

FIG. 4 is a control block diagram of a cell-phone;

FIG. 5 is a sectional view of an image pickup lens shown in Comparative Example;

FIG. 6 shows aberration diagrams (spherical aberration, astigmatism, distortion and meridional coma) of an image pickup lens shown in Comparative Example;

FIG. 7 is a sectional view of an image pickup lens shown in Example 1;

FIG. 8 shows aberration diagrams (spherical aberration, astigmatism, distortion and meridional coma) of an image pickup lens shown in Example 1;

FIG. 9 is a sectional view of an image pickup lens shown in Example 2;

FIG. 10 shows aberration diagrams (spherical aberration, astigmatism, distortion and meridional coma) of an image pickup lens shown in Example 2;

FIG. 11 is a sectional view of an image pickup lens shown in Example 3;

FIG. 12 shows aberration diagrams (spherical aberration, astigmatism, distortion and meridional coma) of an image pickup lens shown in Example 3;

FIG. 13 is a sectional view of an image pickup lens shown in Example 4;

FIG. 14 shows aberration diagrams (spherical aberration, astigmatism, distortion and meridional coma) of an image pickup lens shown in Example 4;

FIG. 15 is a sectional view of an image pickup lens shown in Example 5;

FIG. 16 shows aberration diagrams (spherical aberration, astigmatism, distortion and meridional coma) of an image pickup lens shown in Example 5;

FIG. 17 is a sectional view of an image pickup lens shown in Example 6;

FIG. 18 shows aberration diagrams (spherical aberration, astigmatism, distortion and meridional coma) of an image pickup lens shown in Example 6;

FIG. 19 is a sectional view of an image pickup lens shown in Example 7; and

FIG. 20 shows aberration diagrams (spherical aberration, astigmatism, distortion and meridional coma) of an image pickup lens shown in Example 7.

### DESCRIPTION OF THE PREFERRED EMBODIMENT

The preferred embodiments of the present invention will be described bellow.

A preferred embodiment of the present invention is an image pickup lens for forming an image of an object on a photoelectrical converter of a solid-state image pickup element, and the image pickup lens comprises: a plurality of lenses. A lens having a maximum positive refractive power among the plurality of lenses is a glass lens, and each of the plurality of lenses excluding the lens having the maximum positive refractive power are resin lenses each comprising a curable resin.

In the image pickup lens, each of the resin lenses preferably comprises a curable resin whose glass transition temperature (Tg) is 250° C. or higher.

Further, in the image pickup lens, the curable resin may be an energy-curable resin. Alternatively, the curable resin may be a thermosetting resin.

In the image pickup lens, the glass lens is preferably arranged at a closest position to the object in the image pickup lens.

Further, the image pickup lens preferably satisfies the following expression.

0.7<f1/f<1.1 (1)

Where, f1 is a focal length of a lens arranged at a closest position to the object in the image pickup lens, and f is a focal length of a total system of the image pickup lens.

Another embodiment of the present invention is an image pickup apparatus comprising: a solid-state image pickup element; and the above image pickup lens; and a casing comprising a light-shielding material. In the image pickup apparatus, the solid-state image pickup element, the image pickup lens, and the casing are built in one body. Further, the image pickup apparatus has a height of 10 mm or less in a direction of an optical axis of the image pickup lens.

Another embodiment of the present invention is a mobile terminal comprising the above image pickup apparatus.

These embodiments make it possible to provide an image pickup lens having heat resistance that resists a reflow process and having small fluctuation of an image point position.

Further, by providing the aforesaid image pickup lens, it is possible to obtain an image pickup apparatus for which automatic mounting that uses a reflow process is available, in addition to the aforesaid effects.

Incidentally, it is assumed that “the image pickup apparatus has a height of 10 mm or less in a direction of an optical axis” means a total length of an image pickup apparatus equipped with all of the aforesaid structures in the optical axis direction. Therefore, for example, when a casing is provided on the surface of a base board, and electronic parts are mounted on the back surface of the base board, a distance from the tip portion of the casing closer to the object side to the tip portion of the electronic parts protruded on the back surface is less than 10 mm. Further, “an aperture section for incident light” does not always means an air space such as a hole, but it also means a portion on which an area that can transmit incident light coming from the object side is formed.

Further, the image pickup apparatus relating to the invention provides a high-performance mobile terminal which is further smaller in size.

Embodiments of the invention will be explained in detail as follows, however, the invention is not limited to the description. Incidentally, in the present specification, the expression of “made of resin material” and “comprise resin material” also includes an embodiment in which the resin material is used as a base material and coating process is conducted on the surface of the base material for the purpose of preventing reflection and of enhancing surface hardness.

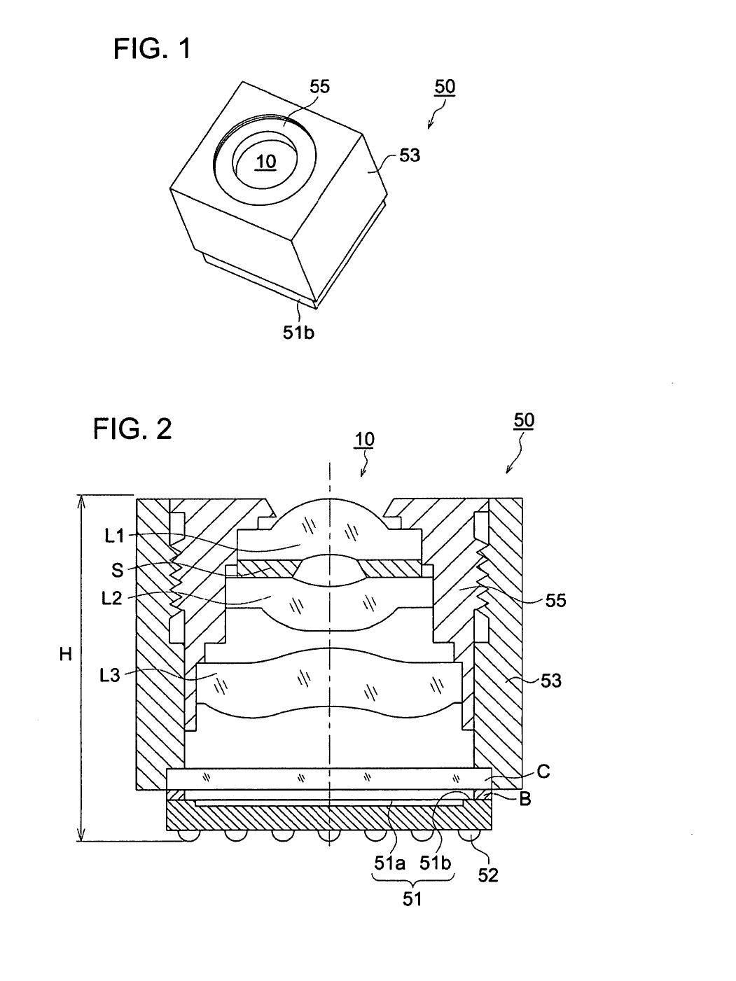

FIG. 1 is a perspective view of image pickup apparatus 50 relating to the present embodiment. FIG. 2 is a diagram schematically showing the section along an optical axis of an image pickup lens of image pickup apparatus 50 relating to the present embodiment.

As shown in FIG. 1 or FIG. 2, the image pickup apparatus 50 is equipped with CMOS type image pickup element 51 representing a solid-state image pickup element having photoelectric conversion section 51a, image pickup lens 10 that forms an image of an object on photoelectric conversion section 51a on the image pickup element 51 and casing 53 composed of a light-shielding member having an opening for incident light coming from the object side. The solid-state image pickup element, the image pickup lens, and the casing are integrally built in one body. Incidentally, the casing 53 is made of a material having heat resistance that resists reflow and having light-shielding effect.

As shown in FIG. 2, there is formed photoelectric conversion section 51a representing a light-receiving section on which pixels (photoelectric conversion elements) are arranged two-dimensionally at a central portion, on the light-receiving side of image pickup element 51, and there is formed signal processing circuit 51b on the circumference of the photoelectric conversion section. This signal processing circuit 51b is composed of a driving circuit section that drives respective pixels in order to obtain signal electric charges, an A/D conversion section that converts signal electric charges into digital signals and a signal processing section that forms image signal output by using the digital signals.

Furthermore, the image pickup element is not limited to the aforesaid image sensor of a CMOS type, and other type of image sensor such as CCD type may also be used.

On the side of the photoelectric conversion section 51a of image pickup element 51, there is fixed seal glass C through spacer B, and further, the side portion of the seal glass C or of the image pickup element 51 is fixed on the casing 53.

On a surface of the other side of the image pickup element 51 (a surface on the opposite side of the image pickup element 51) there are formed plural external electrodes 52 which are used for connection with outer circuits.

The external electrode 52 is connected to an unillustrated outer circuit (for example, a control circuit owned by an upper apparatus on which an image pickup apparatus is mounted). This connection enables the image pickup apparatus to receive the supply of voltage and clock signals to drive the image pickup element 51 from the outer circuit, and to output digital YUV signal to the outer circuit.

It is possible to arrange a base board on the surface of the image pickup element 51 opposite to the photoelectric conversion section 51a, then, to connect the base board with the image pickup element 51 through wire-bonding, and to form plural external electrodes used for connection with outer circuit on the surface of the base board opposite to the image pickup element.

As shown in FIG. 2, the casing 53 is arranged to be fixed on the photoelectric conversion section 51a side of the image pickup element 51.

Image pickup lens 10 is composed of first lens L1, aperture stop S, second lens L2 and third lens L3, in the order from the object side, and they are constructed so that an image of the object may be formed on the photoelectric conversion section 51a of the image pickup element 51. Now then, a one-dot chain line in FIG. 2 represents an optical axis of each of lenses L1-L3.

Infrared blocking coating is conducted on a surface of any one of the first lens L1, the second lens L2, the third lens L3 and the seal glass C. It is also possible to arrange an infrared blocking filter to be ahead of the seal glass, in place of infrared blocking coating.

Respective lenses L1-L3 constituting image pickup lens 10 are supported by lens frame 55 formed with materials having heat resistance that resists reflow and having light-shielding effect. Casing 53 houses therein the lens frame 55 and image pickup lens 10 that is supported by the lens frame 55. The lens frame 55 engages with the casing 53 at its outer circumference.

Incidentally, in the case of the image pickup apparatus shown in FIG. 2, a height of the image pickup apparatus in the direction of the optical axis of the image pickup lens is represented by illustrated H.

It is further possible to arrange a fixed diaphragm that blocks unwanted light between respective lenses L1-L3. In particular, it is preferable to arrange the fixed diaphragm between the second lens and the third lens or between the third lens and seal glass C. It is further possible to arrange a rectangular fixed diaphragm outside an optical path because it can control generation of ghost and flare.

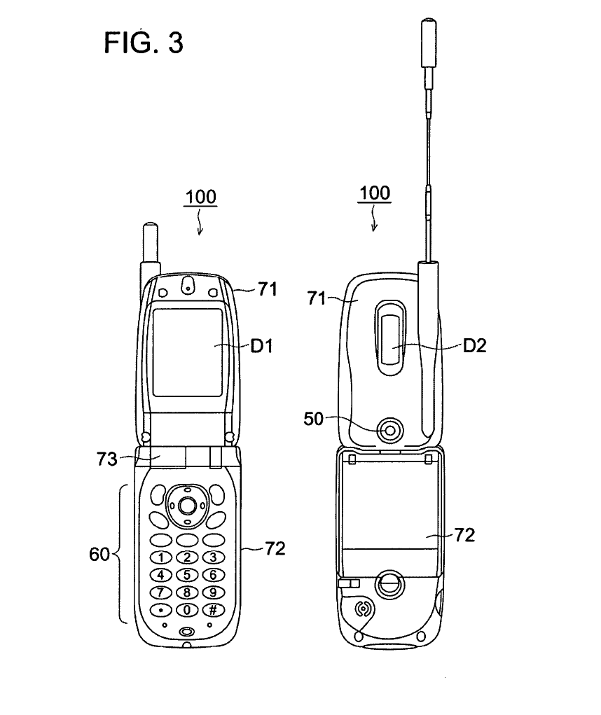

FIG. 3 is an appearance view of a mobile phone 100 which is an example of a mobile terminal provided with the image pickup apparatus 50 of the present embodiment.

In the mobile phone 100 shown in FIG. 3, an upper casing 71 as a case provided with the display image screens D1 and D2, and the lower casing 72 provided with operation buttons 60 which is an input section, are connected with each other through a hinge 73. The image pickup apparatus 50 is housed below the display image screen D2 in the upper casing 71, and the image pickup apparatus 50 is arranged in such a manner that the light can be taken-in from the outer surface side of the upper casing 71.

Hereupon, this image pickup apparatus may also be arranged above or on the side surface of the display image screen D2 in the upper casing 71. Further, it is of cause that the mobile phone is not limited to a folding type.

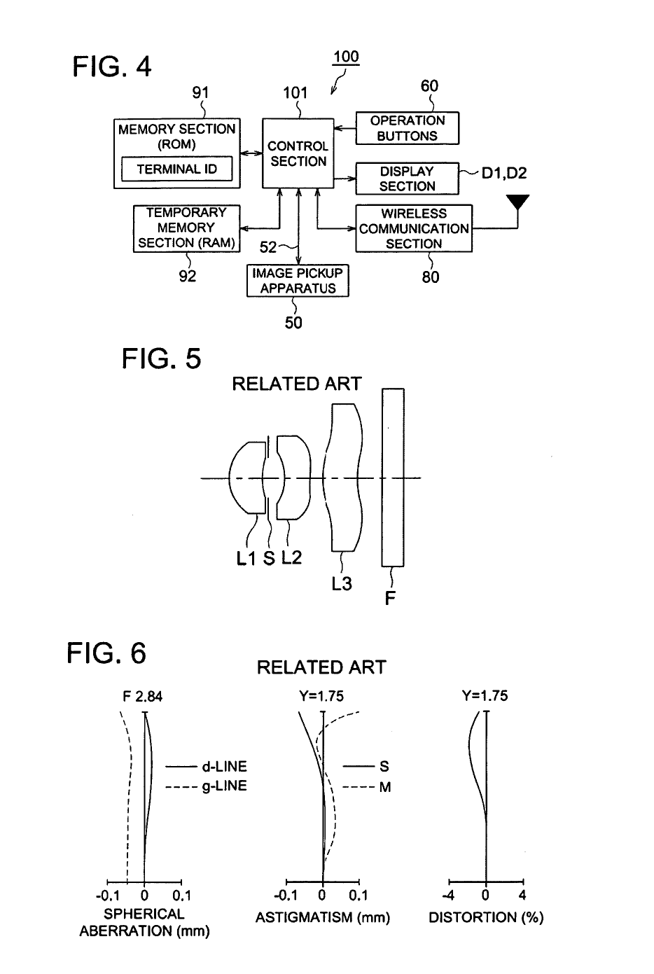

FIG. 4 is a block diagram of the mobile phone 100.

As shown in FIG. 4, the external connecting terminal 52 of the image pickup apparatus 50 is connected to the control section 101 of the mobile phone 100, and the image signal such as the brightness signal or the color difference signal is outputted to the control section 101.

On the one hand, the mobile phone 100 is provided with: a control section (CPU) 101 which generally controls each section and executes the program corresponding to each processing, operation buttons 60 which is an input section for indicating-inputting the number, the display image screens D1 and D2 for displaying the predetermined data display or image picked-up image, a wireless communication section 80 for realizing an each kind of information communication to the external server, a memory section (ROM) 91 which stores the data necessary for the system program of the mobile phone 100 or each kind of processing program or terminal ID, and a temporary memory section (RAM) 92 which temporarily stores each kind of processing program or data or processing data processed by the control section 101, the image data by the image pickup apparatus 50, or is used as a working area.

Further, the image signal inputted from the image pickup apparatus 50 is stored in the memory section 91 by the control section 101 of the mobile phone 100, is displayed on the display image planes D1 and D2, and further is transmitted to the outside as the image information through the wireless communication section 80.

In the present embodiment, the first lens L1 in image pickup lens 10 shown in FIG. 2 is a lens having the maximum positive refractive power, and it is a glass lens made of glass material. Further, the second lens L2 and the third lens L3 each having relatively small refractive power are made of resin materials having excellent heat resistance. Curable resin is used as the resin material excellent in heat resistance. It is preferable that a resin material whose glass transition temperature (Tg) is 250° C. or higher is used as this curable resin because it is possible to provide an image pickup lens having more excellent heat resistance. It is more preferable that a resin material whose glass transition temperature (Tg) is 270° C. or higher is used as the curable resin, because is possible to provide an image pickup lens having further excellent heat resistance. It is still more preferable that a resin material whose glass transition temperature (Tg) is 300° C. or higher is used as the resin material, because it is possible to provide an image pickup lens having still further excellent heat resistance.

As a curable resin material, it is possible to use energy-curable resin material such as, for example, thermosetting resins and active-ray curable resins. The thermosetting resins which can be used include, for example, silicone resin, acrylic resin, epoxy resin, polyimide resin, urethane resin, allyl ester structure resin, resin including adamantane structure, resin including silsesquioxane structure and resin of organic and inorganic hybrid structure. As the active-ray curable resin, UV curable resin is used for example. As the UV curable resin, silicone resin, acrylic resin, epoxy resin, polyimide resin and urethane resin, for example, can be used.

Many of resin materials excellent in heat resistance have a great change, in refractive index caused by temperature changes, compared with polycarbonate resin materials and polyolefin resin materials. A change of refractive index due to temperature changes is expressed as a temperature coefficient of refractive index, and it is defined with dn/dt from relationship between a temperature and a refractive index. The symbol dn/dt is expressed by the following expression (2) by differentiating refractive index n with temperature t based on Lorentz-Lorenz equation.

$$A = \frac{( {n}^{2} + 2 ) ( {n}^{2} - 1 )}{6 n} \{ ( - 3 α ) + \frac{1}{[ R ]} \frac{\partial [ R ]}{\partial t} \} \qquad ( 2 )$$

Where, α represents a coefficient of linear expansion and [R] represents molecular refraction.

In a plastic material, contribution of the second term of the expression (2) is generally small compared with the first term, to be neglected substantially. For example, in PMMA resin, coefficient of linear expansion α is 7×10⁻⁵, and if it is substituted in the aforesaid expression, there is obtained −1.2×10⁻⁴ which agrees with actual measurements substantially.

While dn/dt for polycarbonate resin material is about −14 (10⁻⁵/° C.) and dn/dt for polyolefin resin material is about −11 (10⁻⁵/° C.), dn/dt for the resin material excellent in heat resistance in the embodiment is about from −15 (10⁻⁵/° C.) to −30 (10⁻⁵/° C.). If all lenses are made of resin material excellent in heat resistance for the purpose of mounting with reflow process, image point positions for all lenses are fluctuated, because changes in refractive index caused by temperature changes of the lenses are great.

In many of image pickup lenses in a three-element structure as the present embodiment which is formed of conventional resin materials, resin materials having large Abbe's number are used for the first lens in general, from the viewpoint of axial chromatic aberration. Abbe's number of polyolefin resin material is 56 and Abbe's number of polycarbonate resin material is 30, thus, polyolefin resin material is used for the first lens in general. Further, in the case of the present embodiment, the first lens has the maximum positive refractive power, and a diameter of an axial light flux for F-number is greatest, whereby, the first lens largely affect the fluctuation of the image point position caused by temperature changes. Therefore, when dn/dt of resin material excellent in heat resistance is greater than dn/dt=−11 (10⁻⁵/° C.) of polyolefin resin material, the fluctuation of the image point position caused by temperature changes grows greater, which is not preferable.

On the other hand, glass material has a small change in refractive index due to the temperature change. In general, dn/dt is 1 (10⁻⁵/° C.) or less. Therefore, when a lens having the maximum positive refractive power among all image pickup lenses is formed of glass material and the others are formed of resin materials excellent in heat resistance having a relatively small refractive power, the image point position due to temperature change of the glass lens and a resin lens with small refractive power provides smaller influence of refractive index change caused by temperature changes. Thereby, fluctuations of image point positions of the total system can be controlled to be small.

Further, by forming the first lens of glass material, it is possible to constitute without causing the plastic lenses to be exposed, and a problem of scratches on the first lens can be avoided, resulting in a preferable structure.

Further, if the positive refractive power of the first lens is established to be relatively great as shown in a range of conditional expression (1), the fluctuation of image point position due to temperature changes is controlled to be small, and the so-called telephoto type structure is realized, whereby, a position of a principal point of the optical system can be located on the object side, and an image pickup lens having a short total length can be obtained.

When the lower limit of the expression (1) is exceeded, refractive power of the first lens does not grow greater more than necessary, thereby, the fluctuation of the image point position to become short caused by temperature changes can be controlled, and spherical aberration and coma are controlled to be small. On the other hand, when the upper limit of the expression (1) is not exceeded, the fluctuation of the image point position to become long caused by temperature changes can be controlled, and refractive power of the first lens is secured to be appropriate, and the total length of the image pickup lens can be reduced.

Further, the following conditional expression (1′) is more preferably satisfied.

0.8<f1/f<1.5 (1′)

### EXAMPLES

Examples and Comparative Example of the image pickup lens applied to the above embodiment will be shown below. Symbols used in each of Examples and Comparative Example are as follows:

f: focal length of the total system of the image pickup lens

FB: back focus

F: F number

2Y: diagonal line length of an image pickup surface of the solid-state image pickup element

R: curvature radius

D: interval between surfaces along the axis

Nd: refractive index of the lens material for d-line

vd: Abbe's number of the lens material

In each of Examples and Comparative Example, the shape of the aspheric surface is expressed by the following expression (3) in which the top of the surface is on the origin, x-axis extends along the optical axis direction, and the height perpendicular to the optical axis is h.

$$X = \frac{{h}^{2} / R}{1 + \sqrt{1 - ( 1 + K ) {h}^{2} / {R}^{2}}} + \sum {A}_{i} {h}^{i} \qquad ( 3 )$$

Where, Aᵢ is i-th order of aspheric surface coefficient,

R is a curvature radius,

K is a conical coefficient.

Further, exponent of 10 (for example, 2.5×10⁻⁰²) is expressed by using E (for example, 2.5E−02) in the following description (including the lens data in tables). Further, the surface number of the lens data is affixed in the order in such a manner that the object side of the first lens is made the first surface.

### Comparative Example

Lens data of the image pickup lens in Comparative Example are shown in the following Table 1 and Table 2. An image pickup lens shown in Comparative Example is composed of the first lens having the maximum positive refractive power, the second lens having negative refractive power and the third lens having positive refractive power. Further, all of the first lens, the second lens and the third lens are plastic lenses, and they are formed by curable resin including allyl ester structure and having glass transition temperature (Tg) of 300° C. or higher. Comparative Example shows an example of an amount of fluctuation of image point position caused by temperature changes in the image pickup lens in which all lenses are made of heat resistant resins.

TABLE 1
(Comparative Example)
f = 2.71 fB = 0.29 F = 2.84 Y = 1.75

| Surface | | | | |
|---|---|---|---|---|
| No. | R(mm) | D(mm) | Nd | νd |
| 1 | 0.841 | 0.59 | 1.51300 | 55.9 |
| 2 | 1.559 | 0.10 | | |
| Aperture | ∞ | 0.31 | | |
| stop | | | | |
| 3 | −1.890 | 0.47 | 1.51300 | 55.9 |
| 4 | −702.733 | 0.25 | | |
| 5 | 1.021 | 0.64 | 1.51300 | 55.9 |
| 6 | 2.093 | 0.30 | | |
| 7 | ∞ | 0.40 | 1.51633 | 64.1 |
| 8 | ∞ | | | |

TABLE 2
Aspheric surface coefficient
First surface

| | |
|---|---|
| K = | 2.66520E−01 |
| A4 = | −3.98100E−02 |
| A6 = | 1.26850E−01 |
| A8 = | −6.84870E−01 |
| A10 = | 2.10370E+00 |
| A12 = | −2.32450E+00 |

Second surface

| | |
|---|---|
| K = | 8.92030E+00 |
| A4 = | −1.37230E−01 |
| A6 = | 6.72160E−01 |
| A8 = | −6.50480E+00 |

Third surface

| | |
|---|---|
| K = | 3.36560E−01 |
| A4 = | −5.12320E−01 |
| A6 = | 4.58180E−02 |
| A8 = | −4.37710E+00 |

Fourth surface

| | |
|---|---|
| K = | −1.60230E+00 |
| A4 = | −8.92100E−01 |
| A6 = | 1.31290E+00 |
| A8 = | −1.95130E+00 |
| A10 = | 1.18170E+00 |
| A12 = | −1.87920E−01 |

Fifth surface

| | |
|---|---|
| K = | −6.57370E+00 |
| A4 = | −1.62840E−01 |
| A6 = | 3.45570E−02 |
| A8 = | 1.75630E−02 |
| A10 = | −3.28040E−03 |
| A12 = | −1.39660E−03 |
| A14 = | 3.40420E−04 |

Sixth surface

| | |
|---|---|
| K = | −3.40330E−01 |
| A4 = | −2.23940E−01 |
| A6 = | 4.62210E−02 |
| A8 = | −6.56730E−03 |
| A10 = | 3.03000E−03 |
| A12 = | −4.29420E−04 |
| A14 = | −3.16890E−06 |

FIG. 5 is a sectional view of an image pickup lens shown in Comparative Example. In FIG. 5, there are first lens L1, aperture stop S, second lens L2 and third lens L3. Further, there is a parallel flat plate F assuming an element such as an optical low-pass filter, an infrared blocking filter and seal glass of solid-state image pickup element. In Comparative Example, focal length f1 of the first lens L1 is 2.78 mm, the second lens L2 is a negative lens and focal length f3 of the third lens L3 is 3.23 mm.

FIG. 6 shows aberration diagrams (spherical aberration, astigmatism and distortion) of the image pickup lens shown in Comparative Example.

An image pickup element will be explained as follows, referring to an example of the one having a type of ⅕ inch, a pixel pitch of 1.75 μm and the number of pixels of 1600×1200.

A focal depth is generally expressed by the following expression (4).

Focal depth=±F−number×2×pixel pitch (4)

Since, the focal depth in the case of an image pickup element in Comparative Example is ±0.0099 mm. It is preferable that the fluctuation of image point position is controlled to be the focal depth or less, and it is more preferable that the fluctuation is controlled to be a half of the focal depth or less.

In Comparative Example, in the case of dn/dt=−19 (10⁻⁵/° C.) for the plastic lenses, amount of back focus change (ΔfB) representing an amount of image point position fluctuation in temperature rise by +30° C. for ordinary temperature 20° C. is 0.0279 mm, and amount of back focus change (ΔfB) representing an amount of image point position fluctuation in temperature fall of −30° 0 C. for ordinary temperature 20° C. is −0.0279 mm. Namely, an amount of image point position fluctuation of the image pickup lens shown in Comparative Example is extremely larger than the focal depth.

In this case, amount of back focus change (ΔfB) in the case of temperature rise is a value obtained by ignoring an influence of thermal expansion of a plastic lens in the case of temperature rise and an influence of thermal expansion of a lens barrel that supports a lens, as a calculation. The reason for the foregoing is that the fluctuation of an image point position caused by temperature changes mainly results from changes of refractive index of a plastic lens.

However, when the first lens is assumed to be a glass lens in the above case, dn/dt of each of the second lens and the third lens is made to be −19 (10⁻⁵/° C.) and dn/dt of glass can be neglect because it is extremely small. In this case, amount of back focus change (ΔfB) in temperature rise by +30° C. for ordinary temperature 20° C. is −0.0025 mm, and amount of back focus change (ΔfB) in temperature fall of −30° C. for ordinary temperature 20° C. is 0.0025 mm. Further, when dn/dt of each of the second lens and the third lens is made to be −25 (10⁻⁵/° C.) and dn/dt of the first lens is neglected, amount of back focus change (ΔfB) in temperature rise by +30° C. for ordinary temperature 20° C. is −0.0033 mm, and amount of back focus change (ΔfB) in temperature fall of −30° C. for ordinary temperature 20° C. is 0.0033 mm.

Namely, it is understood that a focal depth of the image pickup element in Comparative Example is ±0.0099 mm, and a fluctuation of an image point position turns out to be a half or less of the focal depth if the first lens having the greatest positive refractive power is replaced by a glass lens.

### Example 1

Lens data of an image pickup lens in Example 1 are shown in the following Table 3 and Table 4. An image pickup lens shown in Example 1 is composed of the first lens having the maximum positive refractive power, the second lens having negative refractive power and the third lens having positive refractive power. Further, the first lens is a glass lens, and the second lens and the third lens are plastic lenses formed by curable resin including allyl ester structure and having glass transition temperature (Tg) of 300° C. or higher.

TABLE 3
(Example 1)
f = 2.70 fB = 0.90 F = 2.84 Y = 1.75

| Surface | | | | |
|---|---|---|---|---|
| No. | R(mm) | D(mm) | Nd | νd |
| 1 | 0.878 | 0.69 | 1.58313 | 59.4 |
| 2 | 1.504 | 0.07 | | |
| Aperture | ∞ | 0.30 | | |
| stop | | | | |
| 3 | −1.462 | 0.56 | 1.51300 | 55.9 |
| 4 | −5.958 | 0.25 | | |
| 5 | 1.074 | 0.67 | 1.51300 | 55.9 |
| 6 | 1.720 | 0.30 | | |
| 7 | ∞ | 0.40 | 1.51633 | 64.1 |
| 8 | ∞ | | | |

TABLE 4
Aspheric surface coefficient
First surface

| | |
|---|---|
| K = | 2.64770E−01 |
| A4 = | −2.02470E−02 |
| A6 = | 5.83670E−02 |
| A8 = | −2.87620E−01 |
| A10 = | 5.58450E−01 |
| A12 = | −5.06960E−01 |

Second surface

| | |
|---|---|
| K = | 8.22210E+00 |
| A4 = | −9.38230E−02 |
| A6 = | 1.12190E−01 |
| A8 = | −3.84040E+00 |

Third surface

| | |
|---|---|
| K = | 1.17430E+00 |
| A4 = | −5.35630E−01 |
| A6 = | −1.32320E−01 |
| A8 = | −4.53980E+00 |

Fourth surface

| | |
|---|---|
| K = | 1.40850E+01 |
| A4 = | −8.65620E−01 |
| A6 = | 1.34150E+00 |
| A8 = | −1.93890E+00 |
| A10 = | 1.18770E+00 |
| A12 = | −1.79230E−01 |

Fifth surface

| | |
|---|---|
| K = | −6.93870E+00 |
| A4 = | −1.64290E−01 |
| A6 = | 3.42140E−02 |
| A8 = | 1.73700E−02 |
| A10 = | −3.44430E−03 |
| A12 = | −1.49290E−03 |
| A14 = | 3.22310E−04 |

Sixth surface

| | |
|---|---|
| K = | −9.09540E−01 |
| A4 = | −2.18070E−01 |
| A6 = | 4.30500E−02 |
| A8 = | −7.47200E−03 |
| A10 = | 2.84290E−03 |
| A12 = | −4.67400E−04 |
| A14 = | −9.30350E−06 |

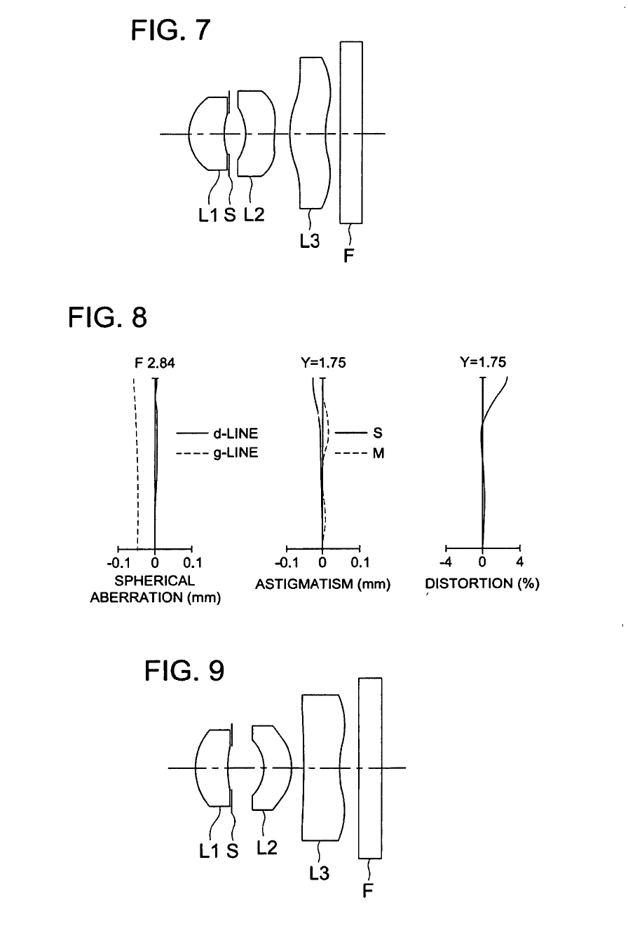

FIG. 7 is a sectional view of an image pickup lens shown in Example 1. In FIG. 7, there are first lens L1, aperture stop S, second lens L2 and third lens L3. Further, there is a parallel flat plate F assuming an element such as an optical low-pass filter, an infrared blocking filter and seal glass of solid-state image pickup element. In Example 1, focal length f1 of the first lens L1 is 2.57 mm, the second lens L2 is a negative lens and focal length f3 of the third lens L3 is 4.12 mm.

FIG. 8 shows aberration diagrams (spherical aberration, astigmatism and distortion) of the image pickup lens shown in Example 1.

When dn/dt of the plastic lenses is made to be −19 (10⁻⁵/° C.) and dn/dt of the glass lens is neglected because its refractive index change due to temperature changes is extremely small, amount of back focus change (ΔfB) in temperature rise by +30° C. for ordinary temperature 20° C. is −0.0042 mm, and amount of back focus change (ΔfB) in temperature fall of −30° C. for ordinary temperature 20° C. is 0.0042 mm.

In an example of the image pickup element having a type of ⅕ inch, a pixel pitch of 1.75 μm and the number of pixels of 1600×1200, a focal depth in the case of the image pickup element in Example 1 is ±0.0099 (mm), and a fluctuation of image point position can be controlled to be a half of the focal depth or less.

### Example 2

Lens data of the image pickup lens in Example 2 are shown in the following Table 5 and Table 6. An image pickup lens shown in Example 2 is composed of the first lens having the maximum positive refractive power, the second lens having positive refractive power and the third lens having negative refractive power. The first lens is a glass lens, and each of the second lens and the third lens is a plastic lens formed with curable resin including allyl ester structure and having glass transition temperature (Tg) of 300° C. or higher.

TABLE 5
(Example 2)
f = 2.70 fB = 0.08 F = 2.84 Y = 1.75

| Surface | | | | |
|---|---|---|---|---|
| No. | R(mm) | D(mm) | Nd | νd |
| 1 | 1.156 | 0.56 | 1.58313 | 59.4 |
| 2 | 3.961 | 0.07 | | |
| Aperture | ∞ | 0.51 | | |
| stop | | | | |
| 3 | −0.880 | 0.47 | 1.51300 | 55.9 |
| 4 | −0.804 | 0.19 | | |
| 5 | 3.640 | 0.62 | 1.51300 | 55.9 |
| 6 | 1.444 | 0.50 | | |
| 7 | ∞ | 0.40 | 1.51633 | 64.1 |
| 8 | ∞ | | | |

TABLE 6
Aspheric surface coefficient
First surface

| | |
|---|---|
| K = | 2.04510E−01 |
| A4 = | −2.21510E−02 |
| A6 = | 9.94860E−02 |
| A8 = | −3.75730E−01 |
| A10 = | 5.89160E−01 |
| A12 = | −4.05700E−01 |

Second surface

| | |
|---|---|
| K = | 9.27340E+00 |
| A4 = | 4.33800E−02 |
| A6 = | −1.30790E+00 |
| A8 = | 1.33800E+01 |
| A10 = | −6.54680E+01 |
| A12 = | 1.19390E+02 |

Third surface

| | |
|---|---|
| K = | 3.77640E−01 |
| A4 = | −1.29990E−01 |
| A6 = | 5.31850E−01 |
| A8 = | −2.94560E+00 |
| A10 = | 1.78520E+01 |
| A12 = | −2.48230E+01 |

Fourth surface

| | |
|---|---|
| K = | −8.00530E−01 |
| A4 = | −9.76580E−02 |
| A6 = | 2.04480E−01 |
| A8 = | 5.37730E−02 |
| A10 = | 1.52520E+00 |
| A12 = | −1.38010E+00 |

Fifth surface

| | |
|---|---|
| K = | −1.13940E+02 |
| A4 = | −1.84840E−01 |
| A6 = | 1.49860E−01 |
| A8 = | −1.74980E−02 |
| A10 = | −2.57430E−02 |
| A12 = | −1.92010E−03 |
| A14 = | 4.61430E−03 |

Sixth surface

| | |
|---|---|
| K = | −1.01630E+01 |
| A4 = | −1.37320E−01 |
| A6 = | 3.65400E−02 |
| A8 = | −1.70110E−02 |
| A10 = | 5.01290E−03 |
| A12 = | −1.66490E−04 |
| A14 = | −4.74550E−04 |

FIG. 9 is a sectional view of an image pickup lens shown in Example 2. In FIG. 9, there are first lens L1, aperture stop S, second lens L2 and third lens L3. Further, there is parallel flat plate F assuming an element such as an optical low-pass filter, an infrared blocking filter and seal glass of solid-state image pickup element. In Example 2, focal length f1 of the first lens L1 is 2.61 mm, focal length f2 of the second lens L2 is 5.87 mm and the third lens L3 is a negative lens.

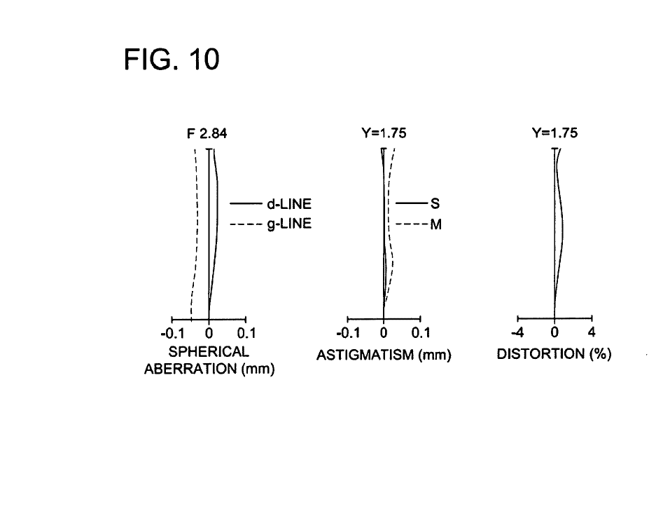

FIG. 10 shows aberration diagrams (spherical aberration, astigmatism and distortion) of the image pickup lens shown in Example 2.

When dn/dt of the plastic lenses is made to be −19 (10⁻⁵/° C.) and dn/dt of the glass lens is neglected because its refractive index change caused by temperature changes is extremely small, amount of back focus change (ΔfB) in temperature rise by +30° C. for ordinary temperature 20° C. is −0.0015 mm, and amount of back focus change (ΔfB) in temperature fall of −30° C. for ordinary temperature 20° C. is 0.0015 mm.

In an example of the image pickup element having a type of ⅕ inch, a pixel pitch of 1.75 μm and the number of pixels of 1600×1200, a focal depth in the case of the image pickup element in Example 2 9s ±0.0099 mm, and a fluctuation of image point position can be controlled to be a half of the focal depth or less.

### Example 3

Lens data of the image pickup lens in Example 3 are shown in the following Table 7 and Table 8. An image pickup lens shown in Example 3 is composed of the first lens having the maximum positive refractive power, the second lens having positive refractive power and the third lens having negative refractive power. The first lens is a glass lens, and each of the second lens and the third lens is a plastic lens formed with acrylic curable resin having glass transition temperature (Tg) of 270° C. 0r higher.

TABLE 7
(Example 3)
f = 2.70 fB = 0.18 F = 2.84 Y = 1.75

| Surface | | | | |
|---|---|---|---|---|
| No. | R(mm) | D(mm) | Nd | νd |
| 1 | 1.272 | 0.59 | 1.58913 | 61.2 |
| 2 | 23.753 | 0.04 | | |
| Aperture | ∞ | 0.41 | | |
| stop | | | | |
| 3 | −0.915 | 0.66 | 1.52700 | 53.7 |
| 4 | −0.785 | 0.27 | | |
| 5 | 41.191 | 0.47 | 1.52700 | 53.7 |
| 6 | 1.444 | 0.40 | | |
| 7 | ∞ | 0.40 | 1.51630 | 64.1 |
| 8 | ∞ | 0.18 | | |

TABLE 8
Aspheric surface coefficient
First surface

| | |
|---|---|
| K = | 1.4238E−02 |
| A4 = | −4.1089E−02 |
| A6 = | 4.3916E−02 |
| A8 = | −4.1786E−01 |
| A10 = | 3.3182E−01 |
| A12 = | −4.7024E−01 |

Second surface

| | |
|---|---|
| K = | 1.3937E+02 |
| A4 = | −6.5424E−02 |
| A6 = | −1.6718E+00 |
| A8 = | 1.2779E+01 |
| A10 = | −5.3097E+01 |
| A12 = | 8.1554E+01 |

Third surface

| | |
|---|---|
| K = | 4.3652E−01 |
| A4 = | −1.6335E−01 |
| A6 = | 2.1901E−01 |
| A8 = | −1.9952E+00 |
| A10 = | 2.3016E+01 |
| A12 = | −4.9451E+01 |

Fourth surface

| | |
|---|---|
| K = | −1.1548E+00 |
| A4 = | 4.7411E−02 |
| A6 = | 1.7726E−02 |
| A8 = | −5.0979E−02 |
| A10 = | 1.6537E+00 |
| A12 = | −1.4190E+00 |

Fifth surface

| | |
|---|---|
| K = | −2.9502E+05 |
| A4 = | −2.5646E−01 |
| A6 = | 2.0903E−01 |
| A8 = | −2.9354E−02 |
| A10 = | −2.8992E−02 |
| A12 = | 5.2496E−04 |
| A14 = | 4.2659E−03 |

Sixth surface

| | |
|---|---|
| K = | −1.2632E+01 |
| A4 = | −1.7268E−01 |
| A6 = | 5.1520E−02 |
| A8 = | −1.8026E−02 |
| A10 = | 4.7973E−03 |
| A12 = | −3.1187E−04 |
| A14 = | −5.2053E−04 |

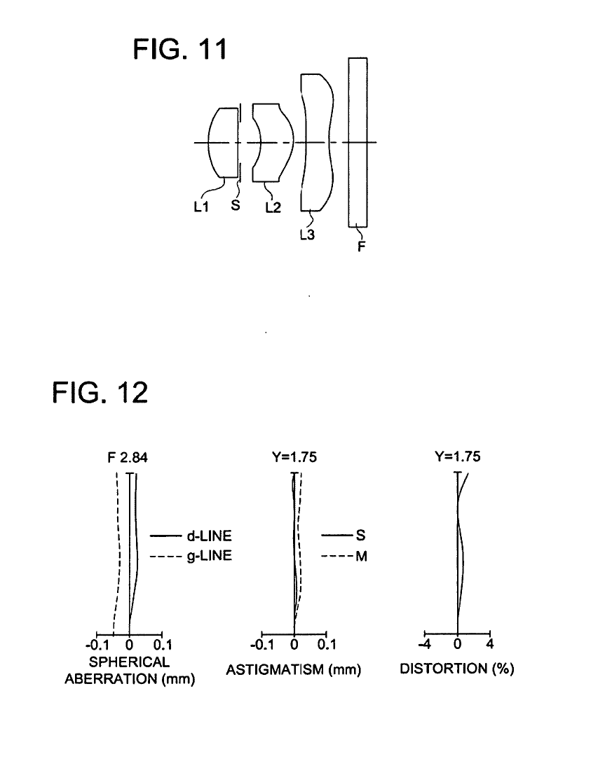

FIG. 11 is a sectional view of an image pickup lens shown in Example 3. In FIG. 11, there are first lens L1, aperture stop S, second lens L2 and third lens L3. Further, there is parallel flat plate F assuming an element such as an optical low-pass filter, an infrared blocking filter and seal glass of solid-state image pickup element. In Example 3, Focal length f1 of the first lens L1 is 2.26 mm, focal length f2 of the second lens L2 is 3.80 mm and the third lens L3 is a negative lens.

FIG. 12 shows aberration diagrams (spherical aberration, astigmatism and distortion) of the image pickup lens shown in Example 3.

When dn/dt of the plastic lenses is made to be −19 (10⁻⁵/° C.) and dn/dt of the glass lens is neglected because its refractive index change caused by temperature changes is extremely small, amount of back focus change (ΔfB) in temperature rise by +30° C. for ordinary temperature 20° C. is −0.0040 mm, and amount of back focus change (ΔfB) in temperature fall of −30° C. for ordinary temperature 20° C. is 0.0040 mm.

In an example of the image pickup element having a type of ⅕ inch, a pixel pitch of 1.75 μm and the number of pixels from 1600×1200, a focal depth in the case of the image pickup element in Example 3 is 0.0099 mm, and a fluctuation of image point position can be controlled to be a half of the focal depth or less.

### Example 4

Lens data of the image pickup lens in Example 4 are shown in the following Table 9 and Table 10. An image pickup lens shown in Example 4 is composed of the first lens having the maximum positive refractive power, the second lens having positive refractive power and the third lens having negative refractive power. The first lens is a glass lens, and each of the second lens and third lens is a plastic lens formed with acrylic curable resin having glass transition temperature (Tg) of 270° C. or higher.

TABLE 9
(Example 4)
f = 2.70 fB = 0.16 F = 2.84 Y = 1.75

| Surface | | | | |
|---|---|---|---|---|
| No. | R(mm) | D(mm) | Nd | νd |
| 1 | 1.126 | 0.69 | 1.48749 | 70.2 |
| 2 | 4.200 | 0.08 | | |
| Aperture | ∞ | 0.55 | | |
| stop | | | | |
| 3 | −0.885 | 0.50 | 1.52700 | 53.7 |
| 4 | −0.711 | 0.10 | | |
| 5 | 2.981 | 0.59 | 1.52700 | 53.7 |
| 6 | 1.180 | 0.50 | | |
| 7 | ∞ | 0.40 | 1.51630 | 64.1 |
| 8 | ∞ | 0.16 | | |

TABLE 10
Aspheric surface coefficient
First surface

| | |
|---|---|
| K = | 7.7701E−01 |
| A4 = | −8.3396E−02 |
| A6 = | 2.2801E−01 |
| A8 = | −1.2994E+00 |
| A10 = | 2.5223E+00 |
| A12 = | −2.2188E+00 |

Second surface

| | |
|---|---|
| K = | 3.4420E+01 |
| A4 = | 1.7912E−01 |
| A6 = | −4.7502E+00 |
| A8 = | 5.4534E+01 |
| A10 = | −2.7672E+02 |
| A12 = | 5.1195E+02 |

Third surface

| | |
|---|---|
| K = | 4.0221E−02 |
| A4 = | −1.6050E−01 |
| A6 = | −2.2555E−01 |
| A8 = | −3.0683E+00 |
| A10 = | 1.4286E+01 |
| A12 = | −1.0330E+01 |

Fourth surface

| | |
|---|---|
| K = | −8.4934E−01 |
| A4 = | −4.6010E−02 |
| A6 = | −1.4826E−01 |
| A8 = | −4.9586E−01 |
| A10 = | 1.7627E+00 |
| A12 = | −6.3055E−01 |

Fifth surface

| | |
|---|---|
| K = | −1.5789E+01 |
| A4 = | −2.7467E−01 |
| A6 = | 2.2303E−01 |
| A8 = | −3.5140E−02 |
| A10 = | −3.1043E−02 |
| A12 = | 6.9801E−04 |
| A14 = | 3.7186E−03 |

Sixth surface

| | |
|---|---|
| K = | −7.2107E+00 |
| A4 = | −1.5884E−01 |
| A6 = | 5.8401E−02 |
| A8 = | −1.8173E−02 |
| A10 = | 4.0385E−03 |
| A12 = | −8.7419E−04 |
| A14 = | −1.2079E−04 |

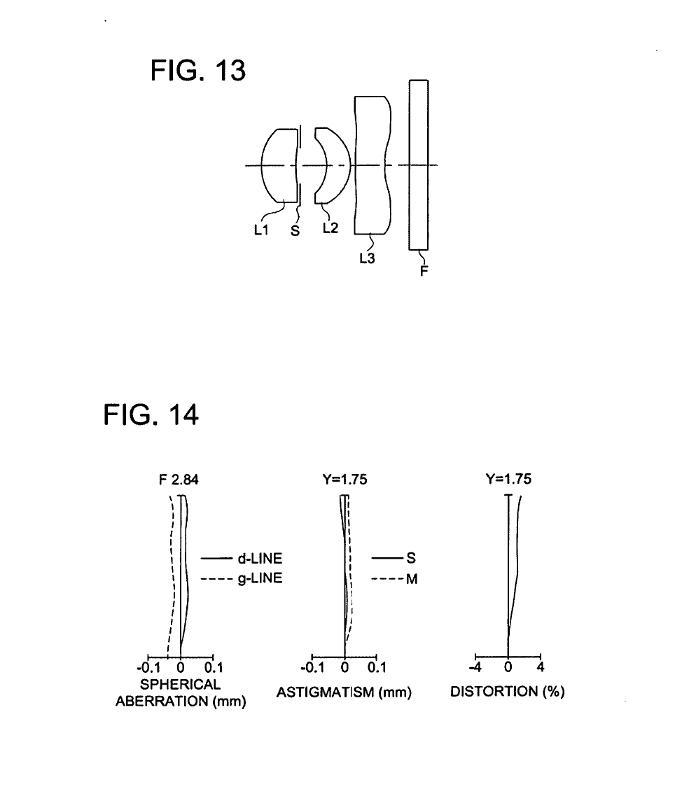

FIG. 13 is a sectional view of an image pickup lens shown in Example 4. In FIG. 13, three are first lens L1, aperture stop S, second lens L2 and third lens L2. Further, a parallel flat plate F assuming an element such as an optical low-pass filter, an infrared blocking filter and seal glass of solid-state image pickup element. In Example 4, focal length f1 of the first lens L1 is 2.94 mm, focal length f2 of the second lens L2 is 3.45 mm and the third lens L3 is a negative lens.

FIG. 14 shows aberration diagrams (spherical aberration, astigmatism and distortion) of the image pickup lens shown in Example 4.

When dn/dt of the plastic lenses is made to be −19 (10⁻⁵/° C.) and dn/dt of the glass lens is neglected because its refractive index change caused by temperature changes is extremely small, amount of back focus change (ΔfB) in temperature rise by +30° C. for ordinary temperature 20° C. is 0.0012 mm, and amount of back focus change (ΔfB) in temperature fall of −30° C. for ordinary temperature 20° C. is −0.0012 mm.

In an example of the image pickup element having a type of ⅕ inch, a pixel pitch of 1.75 μm and the number of pixels of 1600×1200, a focal depth in the case of the image pickup element in Example 4 is ±0.0099 mm, and a fluctuation of image point position can be controlled to be a half of the focal depth or less.

### Example 5

Lens data of the image pickup lens in Example 5 are shown in the following Table 11 and Table 12. An image pickup lens shown in Example 5 is composed of the first lens having the maximum positive refractive power, the second lens having negative refractive power and the third lens having positive refractive power. The first lens is a glass lens, the second lens is a plastic lens formed with curable resin including allyl ester structure and having glass transition temperature (Tg) of 270° C. or higher, and the third lens is a plastic lens formed with curable resin including allyl ester structure and having glass transition temperature (Tg) of 300° C. or higher.

TABLE 11
(Example 5)
f = 2.70 fB = 0.49 F = 2.84 Y = 1.75

| Surface | | | | |
|---|---|---|---|---|
| No. | R(mm) | D(mm) | Nd | νd |
| Aperture | ∞ | 0.00 | | |
| stop | | | | |
| 1 | 2.572 | 0.82 | 1.58313 | 59.4 |
| 2 | −1.784 | 0.46 | | |
| 3 | −0.635 | 0.50 | 1.56700 | 30.0 |
| 4 | −1.342 | 0.10 | | |
| 5 | 1.107 | 0.63 | 1.51300 | 55.9 |
| 6 | 1.479 | 0.40 | | |
| 7 | ∞ | 0.40 | 1.51630 | 64.2 |
| 8 | ∞ | 0.49 | | |

TABLE 12
Aspheric surface coefficient
First surface

| | |
|---|---|
| K = | 6.6169E+00 |
| A4 = | −1.7915E−01 |
| A6 = | −7.1965E−03 |
| A8 = | −7.2931E−01 |
| A10 = | 5.7187E−01 |

Second surface

| | |
|---|---|
| K = | −1.4640E+00 |
| A4 = | −1.8110E−01 |
| A6 = | −2.1033E−01 |
| A8 = | 4.8770E−01 |
| A10 = | −5.1658E−01 |

Third surface

| | |
|---|---|
| K = | −3.1890E+00 |
| A4 = | −4.0884E−01 |
| A6 = | 9.1515E−01 |
| A8 = | 2.4935E−02 |
| A10 = | −1.1436E+00 |
| A12 = | 6.2213E−01 |

Fourth surface

| | |
|---|---|
| K = | −6.3142E−01 |
| A4 = | 5.6962E−02 |
| A6 = | 3.4166E−01 |
| A8 = | 2.1414E−03 |
| A10 = | −4.8791E−02 |
| A12 = | −4.0878E−02 |

Fifth surface

| | |
|---|---|
| K = | −6.3088E+00 |
| A4 = | −7.7278E−02 |
| A6 = | −6.3055E−03 |
| A8 = | 3.9282E−03 |
| A10 = | 6.9327E−03 |
| A12 = | −2.2189E−03 |

Sixth surface

| | |
|---|---|
| K = | −3.1752E+00 |
| A4 = | −1.5053E−01 |
| A6 = | 6.2508E−02 |
| A8 = | −3.2435E−02 |
| A10 = | 9.6651E−03 |
| A12 = | −1.2384E−03 |

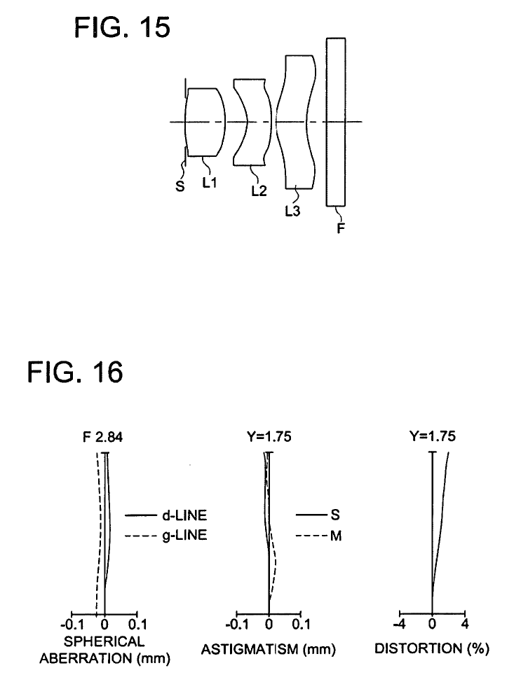

FIG. 15 is a sectional view of an image pickup lens shown in Example 5. In FIG. 15, there are aperture stop S, first lens L1, second lens L2 and third lens L3. Further, there is parallel flat plate F assuming an element such as an optical low-pass filter, an infrared blocking filter and seal glass of solid-state image pickup element. In Example 5, focal length f1 of the first lens L1 is 1.94 mm, the second lens L2 is a negative lens and focal length f3 of the third lens L3 is 5.44 mm.

FIG. 16 shows aberration diagrams (spherical aberration, astigmatism and distortion) of the image pickup lens shown in Example 5.

When dn/dt of the second lens is made to be −16 (10⁻⁵/° C.), dn/dt of the third lens is made to be −19 (10⁻⁵/° C.), and dn/dt of the glass lens is neglected because its refractive index change caused by temperature changes is extremely small, amount of back focus change (ΔfB) in temperature rise by +30° C. for ordinary temperature 20° C. is −0.0042 (mm), and amount of back focus change (ΔfB) in temperature fall of −30° C. for ordinary temperature 20° C. is 0.0042 mm.

In an example of the image pickup element having a type of ⅕ inch, a pixel pitch of 1.75 μm and the number of pixels of 1600×1200, a focal depth in the case of the image pickup element assumed in Example 5 is ±0.0099 mm, and a fluctuation of image point position can be controlled to be a half of the focal depth or less.

### Example 6

Lens data of the image pickup lens in Example 6 are shown in the following Table 13 and Table 14. An image pickup lens shown in Example 6 is composed of the first lens having the greatest positive refractive power, the second lens having negative refractive power and the third lens having positive refractive power. The first lens is a glass lens, the second lens is a plastic lens formed with curable resin including allyl ester structure and having glass transition temperature (Tg) of 270° C. or higher, and the third lens is a plastic lens formed with curable resin including allyl ester structure and having glass transition temperature (Tg) of 300° C. or higher.

TABLE 13
(Example 6)
f = 2.70 fB = 0.52 F = 2.84 Y = 1.75

| Surface | | | | |
|---|---|---|---|---|
| No. | R(mm) | D(mm) | Nd | νd |
| Aperture | ∞ | 0.00 | | |
| stop | | | | |
| 1 | 2.730 | 0.76 | 1.58913 | 61.2 |
| 2 | −1.946 | 0.50 | | |
| 3 | −0.659 | 0.50 | 1.56700 | 30.0 |
| 4 | −1.316 | 0.10 | | |
| 5 | 1.074 | 0.62 | 1.51300 | 55.9 |
| 6 | 1.405 | 0.40 | | |
| 7 | ∞ | 0.40 | 1.51630 | 64.2 |
| 8 | ∞ | 0.52 | | |

TABLE 14
Aspheric surface coefficient
First surface

| | |
|---|---|
| K = | 6.8453E+00 |
| A4 = | −1.7642E−01 |
| A6 = | −1.1112E−02 |
| A8 = | −6.9148E−01 |
| A10 = | 5.8108E−01 |

Second surface

| | |
|---|---|
| K = | −1.6131E+00 |
| A4 = | −1.7833E−01 |
| A6 = | −2.1187E−01 |
| A8 = | 4.7500E−01 |
| A10 = | −5.1728E−01 |

Third surface

| | |
|---|---|
| K = | −3.4278E+00 |
| A4 = | −4.1029E−01 |
| A6 = | 9.2411E−01 |
| A8 = | 3.5666E−02 |
| A10 = | −1.1508E+00 |
| A12 = | 6.2213E−01 |

Fourth surface

| | |
|---|---|
| K = | −5.5369E−01 |
| A4 = | 4.7574E−02 |
| A6 = | 3.4968E−01 |
| A8 = | 9.9776E−03 |
| A10 = | −4.5433E−02 |
| A12 = | −5.0519E−02 |

Fifth surface

| | |
|---|---|
| K = | −5.9607E+00 |
| A4 = | −6.4008E−02 |
| A6 = | −1.1694E−03 |
| A8 = | 2.5687E−03 |
| A10 = | 6.3539E−03 |
| A12 = | −2.1489E−03 |

Sixth surface

| | |
|---|---|
| K = | −3.3417E+00 |
| A4 = | −1.4155E−01 |
| A6 = | 6.4721E−02 |
| A8 = | −3.3220E−02 |
| A10 = | 1.0026E−02 |
| A12 = | −1.2024E−03 |

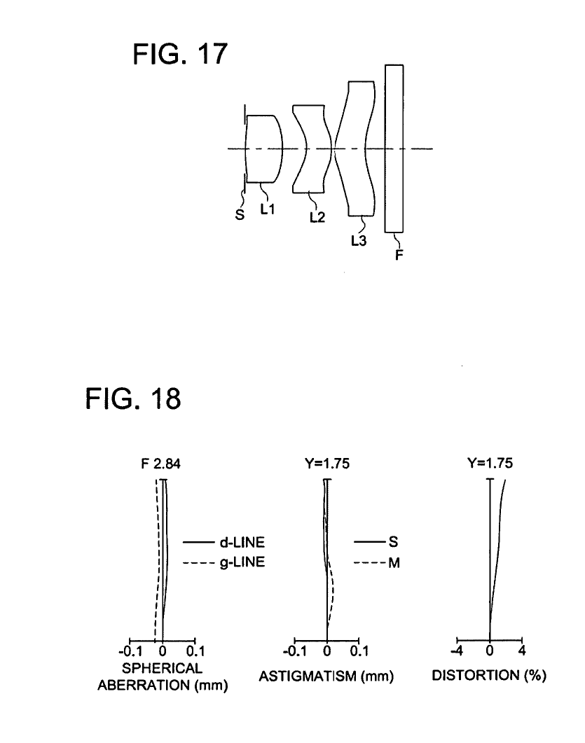

FIG. 17 is a sectional view of an image pickup lens shown in Example 6. In FIG. 17, there are aperture stop S, first lens L1, second lens L2 and third lens L3. Further, there is parallel flat plate F assuming an element such as an optical low-pass filter, an infrared blocking filter and seal glass of solid-state image pickup element. Focal length f1 of the first lens L1 in Example 6 is 2.05 mm, the second lens L2 is a negative lens and focal length f3 of the third lens L3 is 5.42 mm.

FIG. 18 shows aberration diagrams (spherical aberration, astigmatism and distortion) of the image pickup lens shown in Example 6.

When dn/dt of the second lens is made to be −16 (10⁻⁵/° C.), dn/dt of the third lens is made to be −19 (10⁻⁵/° C.), and dn/dt of the glass lens is neglected because its refractive index change caused by temperature changes is extremely small, amount of back focus change (ΔfB) in temperature rise by +30° C. for ordinary temperature 20° C. is −0.0027 mm, and amount of back focus change (ΔfB) in temperature fall of −30° C. for ordinary temperature 20° C. is 0.0027 mm.

In an example of the image pickup element having a type of ⅕ inch, a pixel pitch of 1.75 μm and the number of pixels of 1600×1200, a focal depth in the case of the image pickup element in Example 6 is ±0.0099 mm, and a fluctuation of image point position can be controlled to be a half of the focal depth or less.

### Example 7

Lens data of the image pickup lens in Example 7 are shown in the following Table 15 and Table 16. An image pickup lens shown in Example 7 is composed of the first lens having the maximum positive refractive power, the second lens having negative refractive power and the third lens having positive refractive power. The first lens is a glass lens, and each of the second lens and the third lens is a plastic lens formed with acrylic curable resin having glass transition temperature (Tg) of 270° C. or higher.

TABLE 15
(Example 7)
f = 2.71 fB = 0.57 F = 2.84 Y = 1.75

| Surface | | | | |
|---|---|---|---|---|
| No. | R(mm) | D(mm) | Nd | νd |
| Aperture | ∞ | 0.00 | | |
| stop | | | | |
| 1 | 3.289 | 0.66 | 1.58913 | 61.2 |
| 2 | −2.380 | 0.63 | | |
| 3 | −0.751 | 0.50 | 1.52700 | 53.7 |
| 4 | −1.061 | 0.10 | | |
| 5 | 1.162 | 0.54 | 1.52700 | 53.7 |
| 6 | 1.135 | 0.40 | | |
| 7 | ∞ | 0.40 | 1.51630 | 64.2 |
| 8 | ∞ | 0.57 | | |

TABLE 16
Aspheric surface coefficient
First surface

| | |
|---|---|
| K = | 9.0603E+00 |
| A4 = | −1.6199E−01 |
| A6 = | −1.2222E−02 |
| A8 = | −5.7763E−01 |
| A10 = | 6.1505E−01 |

Second surface

| | |
|---|---|
| K = | −3.4448E+00 |
| A4 = | −1.5668E−01 |
| A6 = | −1.8557E−01 |
| A8 = | 3.0943E−01 |
| A10 = | −2.4695E−01 |

Third surface

| | |
|---|---|
| K = | −4.0523E+00 |
| A4 = | −4.4512E−01 |
| A6 = | 9.2528E−01 |
| A8 = | 1.5495E−01 |
| A10 = | −1.1239E+00 |
| A12 = | 6.2213E−01 |

Fourth surface

| | |
|---|---|
| K = | −4.4350E−01 |
| A4 = | 2.6799E−02 |
| A6 = | 3.6086E−01 |
| A8 = | 4.9500E−02 |
| A10 = | −1.2086E−02 |
| A12 = | −5.2617E−02 |

Fifth surface

| | |
|---|---|
| K = | −6.6610E+00 |
| A4 = | −1.0315E−01 |
| A6 = | 7.3611E−03 |
| A8 = | 3.8930E−04 |
| A10 = | 2.7138E−03 |
| A12 = | −9.4885E−04 |

Sixth surface

| | |
|---|---|
| K = | −4.1250E+00 |
| A4 = | −1.4161E−01 |
| A6 = | 5.8103E−02 |
| A8 = | −3.1323E−02 |
| A10 = | 1.0224E−02 |
| A12 = | −1.6672E−03 |

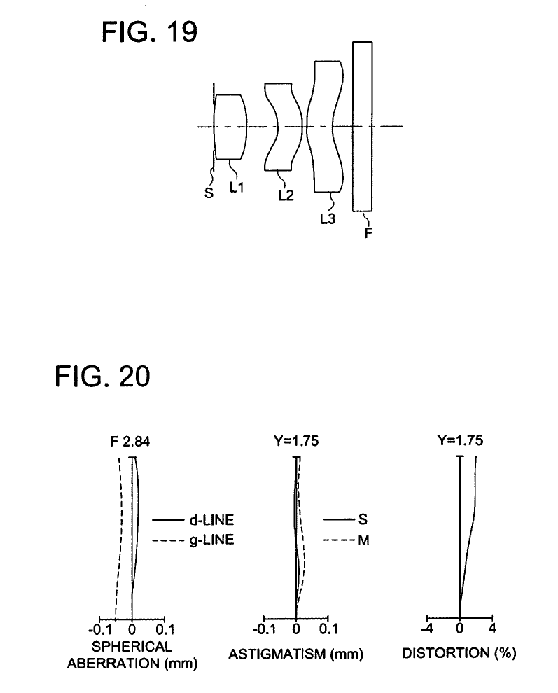

FIG. 19 is a sectional view of an image pickup lens shown in Example 7. In FIG. 19, there are aperture stop S, first lens L1, second lens L2 and third lens L3. Further, there is a parallel flat plate F assuming an element such as an optical low-pass filter, an infrared blocking filter and seal glass of solid-state image pickup element. In Example 7, focal length f1 of the first lens L1 is 2.45 mm, the second lens L2 is a negative lens and focal length f3 of the third lens L3 is 15.66 mm.

FIG. 20 shows aberration diagrams (spherical aberration, astigmatism and distortion) of the image pickup lens shown in Example 7.

When dn/dt of the plastic lenses is made to be −19 (10⁻⁵/° C.) and dn/dt of the glass lens is neglected because its refractive index change caused by temperature changes is extremely small, amount of back focus change (ΔfB) in temperature rise by +30° C. for ordinary temperature 20° C. is −0.0015 mm, and amount of back focus change (ΔfB) in temperature fall of −30° C. for ordinary temperature 20° C. is 0.0015 mm.

In an example of the image pickup element having a type of ⅕ inch, a pixel pitch of 1.75 μm and the number of pixels of 1600×1200, a focal depth in the case of the image pickup element assumed in Example 7 is ±0.0099 mm, and a fluctuation of image point position can be controlled to be a half of the focal depth or less.

Table 17 shows values of f1/f for respective Examples. In Table 17, f1 represents a focal length of the lens closest to the object side and f represents a focal length of the total system of image pickup lenses, and H represents a height in the optical axis direction of the image pickup lens, for the aforesaid Examples 1-7.

TABLE 17

| Examples | f1/f | H |
|---|---|---|
| 1 | 0.95 | 3.35 |
| 2 | 0.97 | 3.40 |
| 3 | 0.84 | 3.43 |
| 4 | 1.09 | 3.57 |
| 5 | 0.72 | 3.80 |
| 6 | 0.76 | 3.80 |
| 7 | 0.90 | 3.80 |

As stated above, it is possible to provide an image pickup lens having heat resistance that resists a reflow process and having small fluctuation of image point position, by creating an image pickup lens wherein a lens having greatest positive refractive power among plural lenses is formed by glass material, and other lenses are resin lenses formed of curable resin material.

In addition, it is possible to constitute without causing plastic lenses to be exposed to the outside by arranging a glass lens to be closest to the subject side, thus, it is possible to provide an image pickup lens and an image pickup apparatus wherein a problem of scratches on the first lens can be avoided.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

For example, though an image pickup element of a type of ⅕ in, a pixel pitch of 1.75 μm and the number of pixels of 1600×1200 has been explained in the aforesaid Examples, an image pickup element to be applied to the image pickup lens and the image pickup apparatus relating to the invention is not naturally limited to the aforesaid image pickup element.

What is claimed is:

1. An image pickup lens for forming an image of an object on a photoelectrical converter of a solid-state image pickup element, the image pickup lens comprising:
a plurality of lenses,
wherein a lens having a maximum positive refractive power among the plurality of lenses is a glass lens, and
each of the plurality of lenses excluding the lens having the maximum positive refractive power are resin lenses each comprising a curable resin.

2. The image pickup lens of claim 1,
wherein each of the resin lenses comprises a curable resin whose glass transition temperature is 250° C. or higher.

3. The image pickup lens of claim 1,
wherein the curable resin is an energy-curable resin.

4. The image pickup lens of claim 1,
wherein the curable resin is a thermosetting resin.

5. The image pickup lens of claim 1,
wherein the glass lens is arranged at a closest position to the object in the image pickup lens.

6. The image pickup lens of claim 1, satisfying a following expression:
0.7<f1/f<1.1,
where f1 is a focal length of a lens arranged at a closest position to the object in the image pickup lens, and
f is a focal length of a total system of the image pickup lens.

7. An image pickup apparatus comprising:
a solid-state image pickup element;
the image pickup lens of claim 1; and
a casing comprising a light-shielding material,
wherein the solid-state image pickup element, the image pickup lens, and the casing are build in one body, and
the image pickup apparatus has a height of 10 mm or less in a direction of an optical axis of the image pickup lens.

8. A mobile terminal comprising:
the image pickup apparatus of claim 7.
